(19) United States
(12) Patent Application Publication
(10) Pub. No.: US 2026/0085968 A1
(43) Pub. Date: Mar. 26, 2026

(54) FIBER OPTIC LOSS AND LENGTH TEST SYSTEMS AND METHODS WITH EMBEDDED FIBER BRAGS SYSTEMS

(71) Applicant: AFL Telecommunications LLC, Duncan, SC (US)

(72) Inventors: Bin Liu, Chestnut Hill, MA (US); David Tanis, Newbury, MA (US); Wenhua Qiu, Concord, NH (US); Scott Prescott, Belmont, NH (US)

(21) Appl. No.: 18/893,278

(22) Filed: Sep. 23, 2024

(51) Int. Cl. G01H 9/00; G01D 5/353

(52) U.S. Cl. CPC G01H 9/004; G01D 5/35316

(57) ABSTRACT

A method for testing an optical fiber, the method including transmitting, from a first light source of an optical power meter at a first time, a first light pulse in a first direction through an optical fiber; reflecting, by a fiber Bragg grating (FBG), the first light pulse in a second direction through the optical fiber, the second direction opposite the first direction; receiving, at the optical power meter, the reflected light pulse at a second time after the first time; determining, by circuitry associated with the optical power meter, a time delay between the first time and the second time; and measuring, by the circuitry, a length of the optical fiber based on the time delay.

### FIELD

The present disclosure relates generally to fiber optic systems and methods utilizing embedded fiber Bragg gratings (FBGs).

### BACKGROUND

Optical fiber networks are used to transmit data between two or more endpoints. Optical fiber networks are typically formed from a plurality of interconnected optical fiber cables. Optical signals can be sent between various locations along the optical fiber network through the plurality of optical fiber cables. Optical transmission requires continuous connectivity of the optical fiber network. Any break within the optical fiber network prevents signal transmission to at least one endpoint within the optical fiber network.

To validate optical fiber networks, it is important to understand the characteristics of the interconnected optical fiber cables. For example, it is important to understand optical power loss incurred as the light travels through the optical fiber cables. Moreover, it is important to understand the length of the optical fiber cables. By understanding the optical power loss and length of the cables, system architects and installation technicians can better layout the optical fiber networks to provide maximum usability with minimal loss and thus improved performance.

Accordingly, improved apparatus and methods for understanding characteristics of the optical fibers are desired in the art. In particular, systems and methods which allow for easy determination of length and loss of the optical fibers would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a method for testing a length of an optical fiber is provided. The method includes emitting, from a first light source of an optical power meter at a first time, a first light pulse in a first direction through an optical fiber; reflecting, by a fiber Bragg grating (FBG), the first light pulse in a second direction through the optical fiber, the second direction opposite the first direction; receiving, at the optical power meter, the reflected light pulse at a second time after the first time; determining, by circuitry associated with the optical power meter, a time delay between the first time and the second time; and measuring, by the circuitry, a length of the optical fiber based on the time delay.

In accordance with another embodiment, an optical fiber length and loss test system is provided. The optical fiber length and loss test system includes a first test equipment comprising a first power meter and a first light source optically branched to a first port; a second test equipment comprising a second light source coupled to a second port; and circuitry in communication with the first test equipment, the circuitry comprising a processor and a memory storing instructions that, when executed by the processor, cause: the first light source to generate a first light pulse transmitted to a first end of an optical fiber through the first port at a first time; the first light pulse to reflect off an FBG disposed at a second end of the optical fiber; the first power meter to receive the reflected first light pulse at a second time; and the circuitry to determine a length of the optical fiber based on a time delay between the first and second times.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a schematic of a system for referencing and testing optical loss measurement in a cable under test in accordance with embodiments of the present disclosure;

FIG. 2 is a schematic of a system for referencing and testing optical loss measurement in a cable under test in accordance with embodiments of the present disclosure;

FIG. 3 is a graph depicting reflectance as a product of wavelength filtering in a fiber Bragg grating in accordance with embodiments of the present disclosure;

FIG. 4 is a schematic of a system for testing optical loss and length in a cable under test in accordance with embodiments of the present disclosure;

FIG. 5 is a generated pulse of light in accordance with embodiments of the present disclosure;

FIG. 6 is a schematic of a system for testing optical loss and length in a cable under test in accordance with embodiments of the present disclosure;

FIG. 7 is a schematic of a system for testing optical loss and length in a cable under test in accordance with embodiments of the present disclosure;

FIG. 8 is a schematic of a system for testing optical loss and length in a cable under test in accordance with embodiments of the present disclosure;

FIG. 9 is a schematic of a system for testing optical loss and length in a cable under test in accordance with embodiments of the present disclosure;

FIG. 10 is a schematic of a multi-fiber push-on (MPO) light source in accordance with embodiments of the present disclosure;

FIG. 11 is a schematic of an MPO light source in accordance with embodiments of the present disclosure;

FIG. 12 is a schematic of an MPO optical power meter in accordance with embodiments of the present disclosure; and

FIG. 13 is a schematic of an MPO optical power meter in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

As used herein, the term “direction” refers to the direction of light travelling from a light source with respect to the media of transmission. In this regard, light travelling in a first direction includes light travelling along the media of transmission before hitting a reflector, such as a mirror, a fiber break, an open UPC connector, or even a microstructure of the transmission media itself. Light travelling in a second direction includes light travelling along the media of transmission after hitting the reflector. The “direction” does not change according to the shape of the transmission media. For instance, the direction does not change when the optical fiber is bent.

As used herein, the term “light source” is intended to refer to a component capable of generating and transmitting light into an optical fiber. The light source may include driver circuitry and/or a pulse generator and a laser driven by the circuitry and/or pulse generator. The laser can emit continuous wave (CW) light or one or more light pulses that are received at the optical fiber. The optical fiber transmits the light pulse(s) which are received at one or more locations. In some instances, the optical fibers provide a single pathway for light to travel through. This may be referred to as single-mode fiber. In other instances, the optical fibers provide various paths, or modes, in which light can travel. This may be referred to as multi-mode fiber. The laser can generate single or multi-mode light that is input into the optical fiber and transmitted therethrough.

Light generated by the laser is received at a measurement device. The measurement device can include a controller. The controller may be in communication with other components of the measurement device. The controller is configured and operable to cause such other components to perform the various operations and method steps as described herein.

The controller may generally include a computer or any other suitable processing unit. For example, the controller may include one or more processor(s) and associated memory device(s) configured to perform a variety of computer-implemented functions, as discussed herein. As used herein, the term “processor” refers not only to integrated circuits referred to in the art as being included in a computer, but also refers to a controller, a microcontroller, a microcomputer, a programmable logic circuit (PLC), an application specific integrated circuit, and other programmable circuits. Additionally, the memory device(s) of the controller may generally comprise local memory element(s) including, but are not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements including remote storage, e.g., in a network cloud. Such memory device(s) may generally be configured to store suitable computer-readable instructions that, when implemented by the processor(s), configure the controller to perform various computer-implemented functions including, but not limited to, performing the various steps discussed herein. In addition, the controller may also include various input/output channels for receiving inputs from and for sending control signals to the various other components of the measurement device, including a light source and the measurement element, sometimes referred to as a power meter.

In various embodiments, the present disclosure is directed to methods of testing an optical system including one or more optical fibers, such as a fiber optic cable or a fiber optic network (e.g., a network comprising one or more cables, at least some of which are fiber optic cables) with a measurement device. It should be understood that in exemplary embodiments, the controller may be utilized to perform some or all of the various method steps as discussed herein.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

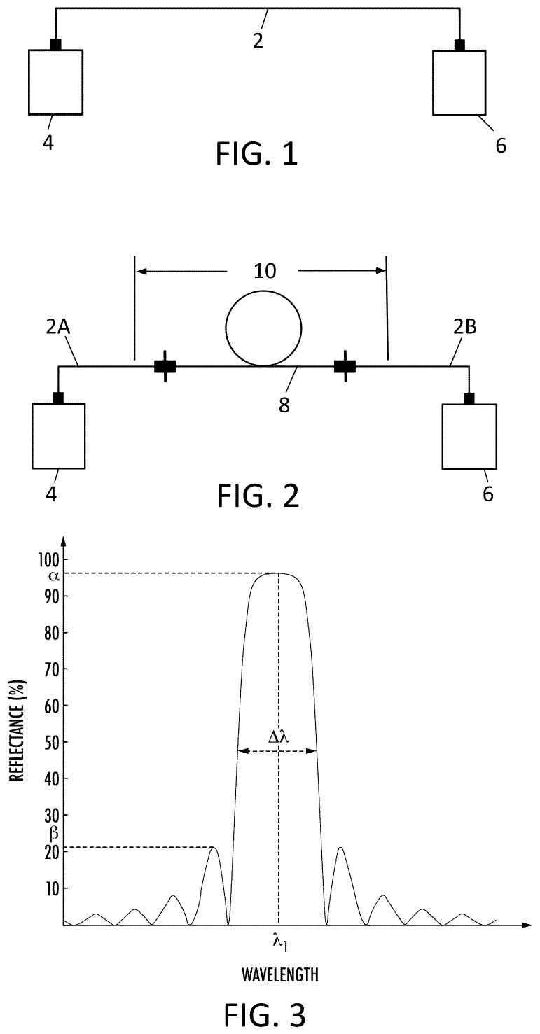

Referring now to the Figures, FIG. 1 illustrates an example referencing and testing procedure for optical loss measurement using a light source power meter (LSPM) method. A test cord 2 is connected between a light source 4 and a power meter 6. Light is emitted from the light source 4 and travels through the test cord 2 to the power meter 6. A reference power measurement of the light is taken by the power meter 6. In this regard, the output optical power from the test cord 2 can be determined.

Referring to FIG. 2, two test cords 2A, 2B are connected between the light source 4 and the power meter 6. For instance, the first test cord 2A is coupled to the light source 4 and the second test cord 2B is coupled to the power meter 6. An optical fiber 8 for testing (also referred to as a cable under test) is connected between the two test cords 2A, 2B. Similar to FIG. 1, light is emitted from the light source 4 and received at the power meter 6. The optical power of the light is measured at the power meter 6. Based on the known reference power from the test cord 2A, and considering the test cord 2B, the optical loss of the optical fiber 8 is determined. For instance, the known optical reference power is subtracted by the output optical power travelling through the optical fiber 8, as measured by the power meter 6. Thus, the optical loss 10 of the optical fiber 8 can be determined.

In addition to testing optical loss in fiber optic network links, the length of a fiber is also commonly required to be measured. To measure length, more sophisticated optical loss test sets (OLTS) are typically required. Each OLTS includes a light source and a power meter linked to a single test port through a fiber optic branching device, e.g., a coupler. An output test light may emit from the light source through the test port. Meanwhile, the power of another input light through the same port can be measured by the power meter. Two OLTS units can be paired for length measurement. Similar to FIGS. 1 and 2, length referencing of a test cord needs to be determined first. A test cord 2A which has a known length connects the test ports of the two OLTS. A test light, commonly a light pulse, is emitted from the light source of one of the OLTS and received by the power meter of the other OLTS. The time of flight of the pulse over the test cord 2A is measured and recorded as a reference. After test cords are referenced, an optical fiber (cable under test) is connected between the test cords and light pulse is emitted from one of the OLTS to the other. The optical loss and length measurement can be performed as described above. However, this method requires two sets of identical light pulse driving, detection, and timer electronics, which may significantly increase the complexity of hardware and software and mechanical size of the OLTS equipment.

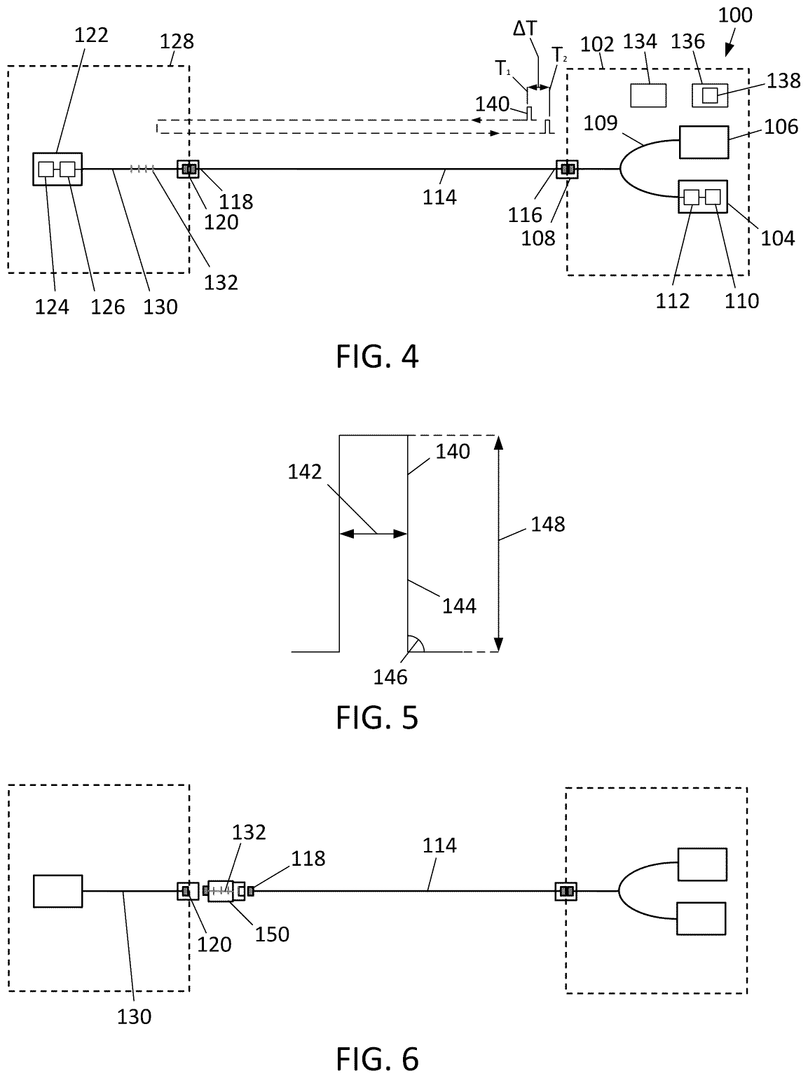

The present disclosure is generally directed to methods and devices which advantageously facilitate improved testing of optical systems, such as optical fibers or fiber optic networks containing multiple optical fibers, including a first optical power meter 100 and methods of using the first optical power meter 100 for testing of an optical system. Referring to FIG. 4, for example, the first optical power meter 100 may include a casing or housing 102 with a first light source 104 and a measurement element 106. The measurement element 106 may be configured to make a measurement of light within the optical system, for example, the measurement element 106 may be an optical power meter. In some embodiments, the first light source 104 and the measurement element 106 may be disposed within the housing 102. The first light source 104 and the measurement element 106 may be connected to a test port 108 by an optical branching device 109 (which may for example include a splitter and/or other suitable device, such as optical fiber couplers, circulator, etc., for providing such branching). Thus, the first light source 104 and the measurement element 106 are both in optical communication with the test port 108 of the first optical power meter 100 via the optical branching device 109. As illustrated for example in FIG. 4, the test port 108 may be at least partially external to the housing 102. The test port 108 may be a contact-based port or contactless port, and a suitable connector of a suitable cable as discussed herein may be connected to the test port 108 to facilitate optical coupling with an optical fiber under test 114. In at least some embodiments, the first light source 104 may include a pulse generator 110 and a laser 112 which is driven by the pulse generator 110 such that the first light source 104 may be operable to emit one or more light pulses as is generally understood in the art. In some embodiments, the measurement element 106 may include a photodiode, as is understood by those of ordinary skill in the art.

A first end 116 of the optical fiber under test 114 can be connected to the test port 108. The optical fiber under test 114 can extend a distance and terminate at a second end 118. The second end 118 of the optical fiber under test 114 can be coupled with a test port 120 of a second light source 122. The second light source 122 can include, for example, a laser driver and/or pulse generator 124 and a laser 126 which is driven by the laser driver and/or pulse generator 124 such that the second light source 122 may be operable to emit CW light or one or more light pulses as is generally understood in the art. The second light source 122 can be housed in a casing or housing 128. An optical fiber 130 can optically couple the second light source 122 to the test port 120. In an embodiment, a fiber Bragg grating (FBG) 132 is disposed along the optical fiber 130.

FBGs 132 generally include gratings formed from a series of refractive index perturbations along an optical fiber. The FBG 132 reflects light traveling in the forward direction in the core of the optical fiber backwards into the core. The reflected light includes less than the entire light profile emitted through the core of the optical fiber as described in greater detail below. The reflected light travels backwards through the core and can be sampled at a remote location.

The FBG 132 can be built in a short segment of the optical fiber 130 and periodically modulate a refractive index of the fiber core. When light propagates through the fiber core and interacts with the FBG 132, and the wavelength of the light, λ_{B}, satisfies the Bragg condition, i.e.,

$${λ}_{B} = 2 \times {n}_{e} \times Λ \qquad ( 1 )$$

the light will be reflected. Light whose wavelength does not meet the Bragg condition is passed through the FBG 132 with little or no perturbation. In Eq. (1), Λ represents the grating period, e.g., it is ˜0.5 μm for a 1550 nm FBG; ne is the effective refractive index of the fiber core, which is ˜1.47 for a typical single mode fiber operating at 1550 nm.

Referring to FIG. 3, the FBG 132 has a reflection waveband with a center Bragg wavelength λ₁ and a full width at half maximum (FWHM) bandwidth Δλ. The center Bragg wavelength λ₁ and bandwidth Δλ can be varied by controlling the structural and material properties of the FBG 132. For example, the period Λ and the refractive index modulation depth Δn can be controlled to vary the center Bragg wavelength and bandwidth. Within the reflection band, a desired reflectance α % can be obtained by controlling the total number of grating periods, i.e., the length of the grating. The FBG 132 can be selected to have a high reflectance, such as, e.g., at least 50%, such as at least 55%, such as at least 60%, such as at least 65%, such as at least 70%, such as at least 75%, such as at least 80%. However, outside the reflection band, such a high reflectance may inevitably introduce sidelobes which can induce unwanted back reflections in the transmission waveband. It is desirable to have the maximum reflectance within the transmission band as low as possible. A desired reflectance may be achieved through adjusting the FBG 132 structurally, e.g., using apodized grating structure.

In an embodiment, the reflection waveband does not interfere with the operational wavebands of one or more other components operating at different wavelengths. The common operation wavebands of a FTTH network and test equipment range from 1260 nm to 1360 nm and 1480-1650 nm. The center Bragg wavelength of the FBG 132 can be selected outside these bands. A wavelength from 650 nm to 1040 nm, or a wavelength from 1390 nm to 1450 nm, or a longer wavelength beyond 1650 nm may be appropriate. For example, a wavelength of 1430 nm may be appropriate. The desired reflection bandwidth may be selected according to the application requirements. Typically, it is set around ±5 nm, which may be wide enough to well compensate possible temperature-dependent wavelength shift of an optical test source and Bragg wavelength.

Referring again to FIG. 4, the FBG 132 may have an example center Bragg wavelength of 1430 nm. The second light source 122 has a center operational wavelength of 1550 nm. Thus, light emitted from the second light source 122 can pass through the FBG 132 unperturbed. The first light source 104 can have a center operational wavelength of 1430 nm. In this regard, a laser pulse (1430 nm) from the first light source 104 that travels along the cable under test 114 is reflected by the FBG 132 back to the optical power meter 100.

The following description illustrates an operational scheme of the optical power meter 100 and second light source 122 in accordance with an example embodiment. It should be understood that the figure and accompanying description are merely illustrative and are not intended to be limiting. Moreover, the figure is drawn as a schematic and is not intended to be limiting. To measure optical power loss, light is emitted from the second light source 122. A CW light may be generated by the laser driver 124 and the laser 126 emits the generated light along the optical fiber 130. The generated light has a center wavelength different from a center Bragg wavelength of the FBG 132. The generated light travels through the FBG 132 (unperturbed) and passes through the cable under test 114. The generated light enters the optical power meter 100, travels along the optical branching device 109 and enters the power meter 106 of the optical power meter 100. The power meter 106 can measure the optical power loss in view of the known optical power generated by the second light source 122 or through reference power measurement as shown, for example, in FIG. 1. More particularly, circuitry including, for example, one or more processors 134 in communication with the optical power meter 100, can determine the optical power loss of the cable under test 114.

The processor(s) 134 can be any suitable processing device (e.g., a control circuitry, a processor core, a microprocessor, an application specific integrated circuit, a field programmable gate array, a controller, a microcontroller, etc.) and can be one processor or a plurality of processors that are operatively connected. A memory 136 can include one or more non-transitory computer-readable storage media, such as RAM, ROM, EEPROM, EPROM, one or more memory devices, flash memory devices, etc., and combinations thereof. The memory 136 can store information that can be accessed by the processor(s) 134. For instance, the memory 136 (e.g., one or more non-transitory computer-readable storage mediums, memory devices) can include computer-readable instructions 138 that can be executed by the processor(s) 134. The instructions 138 can be software, firmware, or both written in any suitable programming language or can be implemented in firmware or hardware. Additionally, or alternatively, the instructions 138 can be executed in logically and/or virtually separate threads on processor(s) 134. For example, the memory 136 can store instructions 138 that when executed by the processor(s) 134 cause the processor(s) 134 to perform operations such as any of the operations and functions as described herein. In some instances, the processor(s) 134 may be integral with the optical power meter 100. In other instances, the optical power meter 100 can include a communication interface configured to communicate with an external device (local or remote) which includes one or more processors that can determine the optical loss of the cable under test 114.

The optical power meter 100 can be further used to determine a length of the cable under test 114. For example, a light pulse 140 is generated by the pulse generator 110 and the laser 112 emits the generated light pulse 140 onto the optical branching device 109. The generated light pulse 140 has a center wavelength that is equal, or substantially equal, to the center Bragg wavelength of the FBG 132. The generated light pulse 140 travels to the cable under test 114 through the test port 108 and travels along a length of the cable under test 114 in a first direction from the first end 116 to the second end 118. The generated light pulse 140 passes through the test port 120 and travels along the optical fiber 130 until reaching the FBG 132. Since the center wavelength of the generated light pulse is equal to the center Bragg wavelength (e.g., each 1430 nm), the generated light pulse 140 reflects from the FBG 132, through the cable under test 114 back to the test port 108 in a second direction different than, e.g., opposite, the first direction. The reflected light pulse 140 enters the optical branching device 109 and travels to the power meter 106.

The optical power meter 100 can record a first time T₁ associated with a moment the generated light pulse 140 is transmitted to the cable under test 114 or another similar reference time. The first time T₁ can be recorded, for example, at the memory 136. The optical power meter 100 can further record a second time T₂ associated with a moment the light is received from the cable under test 114 or another similar reference time. The second time T₂ can be recorded, for example, at the memory 136. The circuitry can determine a time delay (ΔT) between the first time T₁ and the second time T₂. The circuitry can determine a length of the cable under test 114 based on the time delay (ΔT). For example, the circuitry can determine the total time delay between the moment of transmission (T₁) and the moment of receiving the reflected light pulse 140 (T₂) and divide the total time therebetween by two (2) to account for directional travel of the light pulse 140 along the cable under test 114 in both the first and second directions.

Accordingly, the optical power meter 100 can determine the length of the cable under test 114 and the optical power loss of the cable under test 114 using a single optical power meter 100. The second light source 122 does not require detection and timer circuitry. Thus, a cost of the second light source 122 is reduced and the overall testing of the cable under test 114 can be performed cheaper and with less complex hardware.

Referring to FIG. 5, the generated light pulse 140 may generally have a rectangular waveform and an arbitrary pulse width. However, a short pulse width 142 may be advantageous in suppressing photo detection noises such as caused by backscattered lights, such as less than 50 microseconds, such as less than 10 microseconds, such as less than 5 microseconds, such as less than 100 nanoseconds, such as less than 50 nanoseconds, such as less than 20 nanoseconds, such as less than 10 nanoseconds, such as less than 5 nanoseconds, such as less than 3 nanoseconds, such as less than 2 nanoseconds, such as less than 1 nanosecond. In an embodiment, the light pulse 140 has a pulse width 142 less than 1 microsecond. The light pulse 140 can be a rectangular light pulse having a sharp leading edge 144. That is, the leading edge 144 of the light pulse 140 can be steep such that receipt of the light pulse 140 occurs instantaneously, or nearly instantaneously, (i.e., without delay) which might occur if the leading edge 144 were slanted, curved, or otherwise significantly offset from a sharp leading edge. As used herein, a sharp leading edge 144 is intended to refer to a linear leading edge having a relative angle 146 between 90° and 100°, such as between 90° and 98°, such as between 90° and 96°, such as between 90° and 94°, such as between 90° and 92°. In an embodiment, the relative angle 146 is 90°. The use of a short pulse width and steep leading edge 144 causes the generated light pulse 140 to be easily timed and the time delay to be more accurately measured. For example, a shallow leading edge (e.g., a leading edge having a relative angle 146 under 45°) may not be detected when the leading edge 144 reaches the optical power meter 100 as detection requires some critical threshold pulse amplitude 148. This critical threshold pulse amplitude 148 may not be incurred without some lag time (TLAG) after the initial leading edge 144 reaches the optical power meter 100. This would affect the length measurement and reduce effectiveness of the testing protocol.

FIG. 6 illustrates the testing equipment in accordance with another embodiment. In the embodiment depicted in FIG. 6, the FBG 132 is disposed within a socket-plug-type connector 150. The socket-plug-type connector 150 may be coupled between the test port 120 and the cable under test 114. In this regard, the optical fiber 130 does not need to be retrofit or manufactured with an integral FBG 132 (as depicted, for example, in FIG. 4). That is, unlike the embodiment depicted in FIG. 4, the embodiment depicted in FIG. 6 allows for reflection of the generated light pulse 140 (FIG. 4) at a location external to the casing or housing 128 of the second light source 122. Instead, the FBG 132 can be incorporated (e.g., retrofit) into the test equipment through an auxiliary device (i.e., the socket-plug-type connector 150) that can be coupled to the equipment and does not require installation during assembly of the test equipment. In the depicted embodiment, the socket-plug-type connector 150 is disposed directly between the test port 120 and the second end 118 of the cable under test 114. In another embodiment, the socket-plug-type connector 150 can be separated from one or both of the test port 120 and/or cable under test 114 by an intermediate cable (sometimes referred to as a jumper cable). It should be understood that testing of the intermediate cable may be required to account of length and/or optical loss in the intermediate cable.

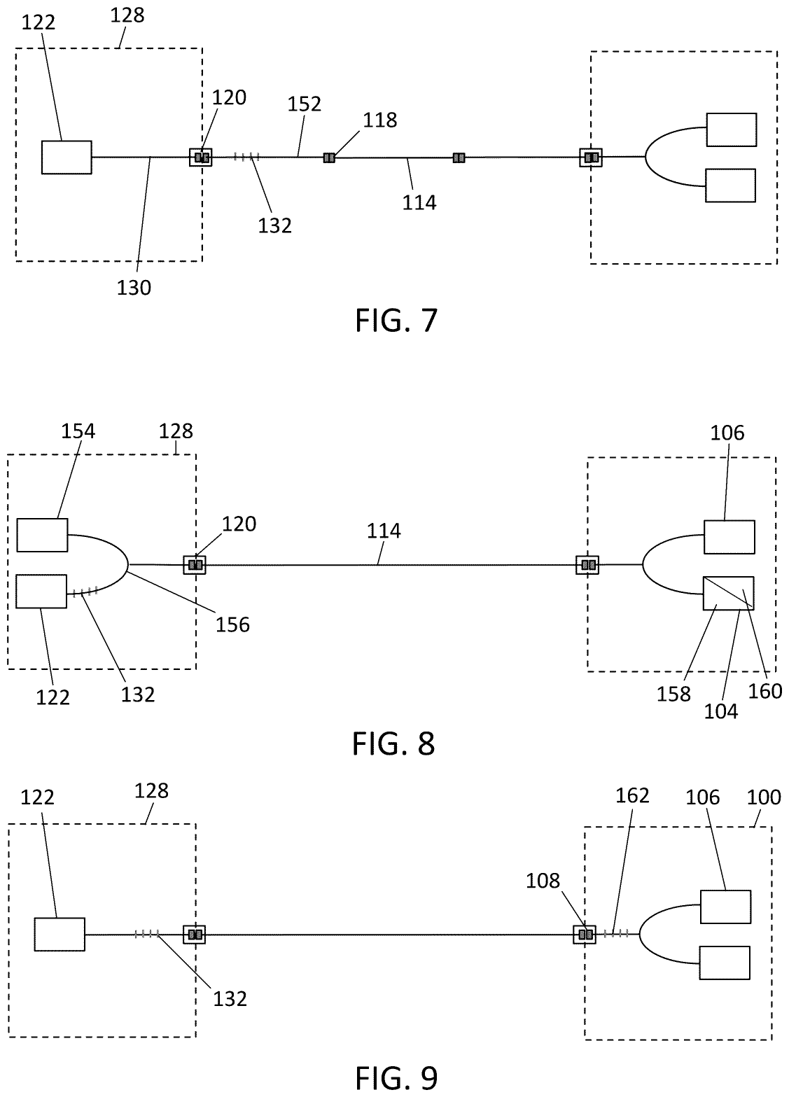

FIG. 7 illustrates the testing equipment in accordance with another embodiment. In the embodiment depicted in FIG. 7, the FBG 132 is disposed within a cable-type connector 152. The cable-type connector 152 may be coupled between the test port 120 and the cable under test 114. In this regard, similar to the embodiment depicted in FIG. 6, the optical fiber 130 does not need to be retrofit or manufactured with an integral FBG 132 (as depicted, for example, in FIG. 4). That is, unlike the embodiment depicted in FIG. 4, the embodiment depicted in FIG. 7 allows for reflection of the generated light pulse 140 (FIG. 4) at a location external to the casing or housing 128 of the second light source 122. Instead, the FBG 132 can be incorporated (e.g., retrofit) into the test equipment through an auxiliary device (i.e., the cable-type connector 152) that can be coupled to the equipment and does not require installation during assembly of the test equipment. In the depicted embodiment, the cable-type connector 152 is disposed directly between the test port 120 and the second end 118 of the cable under test 114. In another embodiment, the cable-type connector 152 can be separated from one or both of the test port 120 and/or cable under test 114 by an intermediate cable (sometimes referred to as a jumper cable). It should be understood that testing of the intermediate cable may be required to account of length and/or optical loss in the intermediate cable.

FIG. 8 illustrates the testing equipment in accordance with another embodiment. Similar to the embodiment depicted in FIG. 4, the testing equipment depicted in FIG. 8 includes the FBG 132 integrated into the casing or housing 128 associated with the second light source 122. However, unlike the embodiment depicted in FIG. 4 which includes only the second light source 122, the embodiment depicted in FIG. 8 includes both the second light source 122 and a second measurement element 154. The second light source 122 and the second measurement element 154 can be coupled together through an optical branching device 156 (which may for example include a splitter and/or other suitable device, such as optical fiber couplers, circulator, etc., for providing such branching). Thus, the second light source 122 and the second measurement element 154 are both in optical communication with the test port 120 via the optical branching device 156.

The measurement element 106 can receive light emitted from the second light source 122 to measure optical loss in the second direction (left to right in FIG. 8). The second measurement element 154 can receive light emitted from the first light source 104 to measure optical loss in the first direction (right to left in FIG. 8). In this regard, the testing equipment depicted in FIG. 8 can be used to conduct bidirectional optical loss measurements. Optical loss measurements and length measurements can be performed using light with different wavelengths. For example, optical loss can be performed using a first wavelength 158 and length measurements can be performed using a second wavelength 160. The FBG 132 can reflect the second wavelength 160 to permit length measurement by the measurement element 106. In an embodiment, the FBG 132 may alternatively be used with a socket-plug-type connector 150 (FIG. 6) or a cable-type connector 152 (FIG. 7). It is noted that implementations described herein may allow for loss testing at a plurality of wavelengths (e.g., 1310 nm and 1550 nm). For example, the embodiment depicted in FIG. 8 may operate with the light source 122 at a different wavelength than both the first and second wavelengths 158 and 160, thereby allowing multi-wavelength loss testing.

FIG. 9 illustrates the testing equipment in accordance with another embodiment. Similar to the embodiment depicted in FIG. 4, the testing equipment depicted in FIG. 9 includes the FBG 132 integrated into the casing or housing 128 associated with the second light source 122. However, unlike the embodiment depicted in FIG. 4, the testing equipment depicted in FIG. 9 further includes a second FBG 162 disposed in the optical power meter 100. The second FBG 162 may have a center Bragg wavelength that is different than the center Bragg wavelength of the FBG 132. In some instances, the second FBG 162 can be used in the embodiment depicted in FIG. 8, such as between the measurement element 106 and the test port 108, or with a socket-plug-type connector 150 (FIG. 4) coupled to the test port 108, or with a cable-type connector 152 (FIG. 6) coupled to the test port 108, etc.

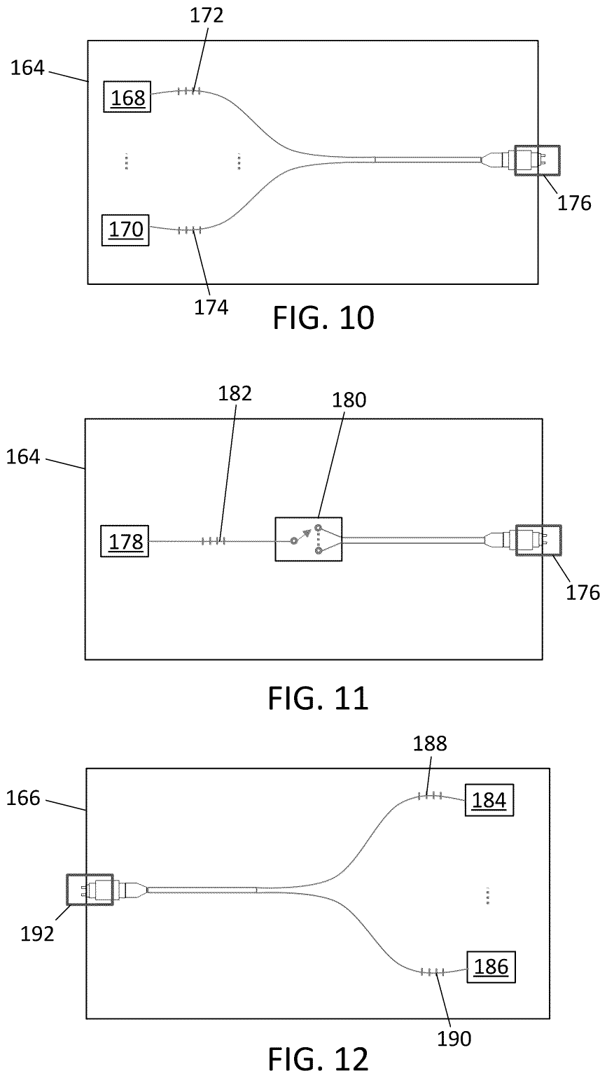

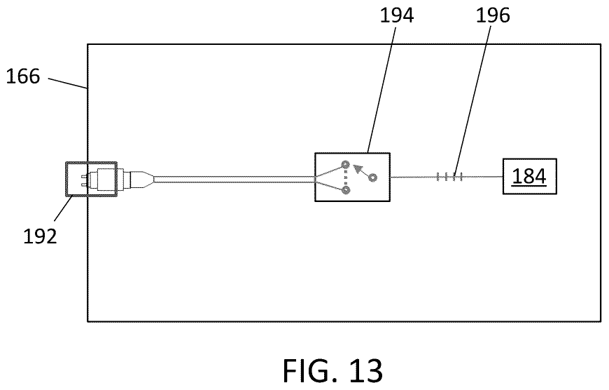

FIGS. 10 to 13 illustrate embodiments of testing equipment for use in a multi-fiber light source used with a multi-fiber push-on (MPO) cable. In particular, FIGS. 10 and 11 each illustrate an embodiment of an MPO light source 164, and FIGS. 12 and 13 each illustrate an embodiment of an MPO optical power meter 166. The MPO light source 164 may be substantially similar to the second light source 122 described above. The MPO optical power meter 166 may be substantially similar to the optical power meter 100 described above. However, each of the MPO light source 164 and optical power meter 100 are configured to be used with an MPO cable.

Referring initially to FIG. 10, the MPO light source 164 can include a first light source 168 and a number N of additional light sources 170. The number N of additional light sources 170 can include one additional light source 170, two additional light sources 170, three additional light sources 170, four additional light sources 170, or more additional light sources 170. The first light source 168 can be coupled in series with an FBG 172. The additional light sources 170 can each be coupled in series with an FBG 174. The light sources 168, 170 can be coupled to an MPO connector 176 that allows for coupling of the MPO light source 164 with a cable under test (not illustrated).

As depicted in FIG. 11, the MPO light source 164 can instead include a light source 178 coupled to the MPO connector 176 through an optical switch 180 that allows the light source 178 to be emitted into each optical fiber of the MPO cable. An FBG 182 can be disposed between the light source 178 and the MPO connector 176. For example, the FBG 182 can be disposed between the light source 178 and the switch 180. The FBG 182 can operate similar to the previously described FBG 132 to reflect light for testing.

FIG. 12 depicts the MPO optical power meter 166 in accordance with an embodiment. The MPO optical power meter 166 can include a first power meter 184 and a number N of additional power meters 186. The number N of additional power meters 186 can include one additional power meter 186, two additional power meters 186, three additional power meters 186, four additional power meters 186, or more additional power meters 186. The first power meter 184 can be coupled in series with an FBG 188. The additional power meters 186 can each be coupled in series with an FBG 190. The power meters 184, 186 can be coupled to an MPO connector 192 that allows for coupling of the MPO optical power meter 166 with a cable under test (not illustrated).

As depicted in FIG. 13, the MPO optical power 166 can instead include a power meter 184 coupled to the MPO connector 192 through an optical switch 194 that allows the power meter 184 to receive light from each optical fiber of the MPO cable. An FBG 196 can be disposed between the switch 194 and the power meter 184. The FBG 196 can operate similar to the previously described FBG 132.

Further aspects of the invention are provided by one or more of the following embodiments:

Embodiment 1. A method for testing the length and loss of an optical fiber, the method comprising: emitting, from a first light source of an optical power meter at a first time, a first light pulse in a first direction through an optical fiber; reflecting, by a fiber Bragg grating (FBG), the first light pulse in a second direction through the optical fiber, the second direction opposite the first direction; receiving, at the optical power meter, the reflected light pulse at a second time after the first time; determining, by circuitry associated with the optical power meter, a time delay between the first time and the second time; and measuring, by the circuitry, a length of the optical fiber based on the time delay.

Embodiment 2. The method of embodiment 1, wherein the first light pulse is a rectangular light pulse with a pulse width less than 50 microseconds.

Embodiment 3. The method of any one or more of the previous embodiments, wherein the method further comprises: coupling a first end of the optical fiber to the optical power meter; and coupling a second end of the optical fiber to a second light source, wherein the FBG is disposed between the second end of the optical fiber and the second light source.

Embodiment 4. The method of embodiment 3, wherein the method further comprises measuring a one-directional optical power loss by: transmitting, from the second light source, a CW light through the optical fiber in the second direction; receiving, at the optical power meter, the transmitted CW light; and measuring, by the optical power meter, an optical power loss of the optical fiber based on a power of the received CW light.

Embodiment 5. The method of embodiment 4, wherein the method further comprises measuring a bidirectional optical power loss by: receiving, at a power meter of the second light source, at least a portion of the CW light; and measuring, by the power meter of the second light source, the optical power loss of the optical fiber based on a power of the received first light.

Embodiment 6. The method of embodiment 4, wherein the method further comprises measuring a bidirectional optical power loss by: receiving, at a power meter of the second light source, a CW test light transmitted from the first light source; and measuring, by the power meter of the second light source, the optical power loss of the optical fiber based on the received CW test light.

Embodiment 7. The method of any one or more of embodiments 3 to 6, wherein coupling the second end of the optical fiber to the light source comprises: coupling the optical fiber directly to the second light source; coupling the optical fiber to a socket-plug-type connector and coupling the socket-plug-type connector to the second light source; or coupling the optical cable to a cable-type connector and coupling the cable-type connector to the second light source.

Embodiment 8. The method of any one or more of the previous embodiments, wherein measuring the length of the optical fiber based on the time delay comprises multiplying the time delay by a speed of light as measured in a fiber and dividing the resultant by a divisor, the divisor calculated as two minus a total length of a test cord.

Embodiment 9. The method of any one or more of the previous embodiments, wherein the optical fiber is an MPO cable, and wherein the method further comprises successively switching an optical switch between different optical fibers of the MPO cable and measuring the length of the optical fibers based on the time delays.

Embodiment 10. The method of any one or more of the previous embodiments, wherein the first light pulse is emitted onto the optical fiber at a first end of the optical fiber, and wherein the FBG is disposed at a second end of the optical fiber.

Embodiment 11. An optical fiber loss and length test system comprising: a first test equipment comprising a first power meter and a first light source optically branched to a first port; a second test equipment comprising a second light source coupled to a second port; and circuitry in communication with the first test equipment, the circuitry comprising a processor and a memory storing instructions that, when executed by the processor, cause: the first light source to generate a first light pulse transmitted to a first end of an optical fiber through the first port at a first time; the first light pulse to reflect off an FBG disposed at a second end of the optical fiber; the first power meter to receive the reflected first light pulse at a second time; and the circuitry to determine a length of the optical fiber based on a time delay between the first and second times.

Embodiment 12. The optical fiber loss and length test system of embodiment 11, wherein the second light source is configured to generate a CW test light, the CW test light received at the first power meter, wherein the circuitry is configured to determine optical power loss of the optical cable based on a power of the received CW test light.

Embodiment 13. The optical fiber loss and length test system of any one or more of embodiments 11 or 12, wherein the second test equipment further comprises a second power meter, wherein the second power meter is configured to receive at least a portion of a CW test light generated by the first light source, and wherein circuitry in communication with the second test equipment is configured to determine optical power loss of the optical cable based on a power of the received CW test light.

Embodiment 14. The optical fiber loss and length test system of any one or more of embodiments 11 to 13, wherein the FBG is disposed external to the optical fiber, and wherein the FBG is disposed at the second equipment, in a socket-plug-type connector, or in a cable-type connector.

Embodiment 15. The optical fiber loss and length test system of embodiment 14, wherein the socket-plug-type connector or cable-type connector are disposed between the second end of the optical fiber and the second equipment.

Embodiment 16. The optical fiber loss and length test system of any one or more of embodiments 11 to 15, wherein the first light pulse is a rectangular light pulse with a pulse width less than 50 microseconds.

Embodiment 17. The optical fiber loss and length test system of any one or more of embodiments 11 to 16, wherein the FBG is configured to reflect a λ₁ wavelength, wherein the first light pulse has a λ₂ wavelength, and wherein λ₂ is approximately equal to λ₁.

Embodiment 18. The optical fiber loss and length test system of any one or more of embodiments 11 to 17, wherein the second test equipment is free of detection and timer circuitry.

Embodiment 19. The optical fiber loss and length test system of any one or more of embodiments 11 to 18, wherein the second test equipment further comprises a power meter, and wherein the optical fiber system is configured for bidirectional optical loss measurements.

Embodiment 20. The optical fiber loss and length test system of any one or more of embodiments 11 to 19, wherein the circuitry determines the length of the optical fiber by dividing the time delay by two.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A method for testing an optical fiber, the method comprising:
emitting, from a first light source of an optical power meter at a first time, a first light pulse in a first direction through an optical fiber;
reflecting, by a fiber Bragg grating (FBG), the first light pulse in a second direction through the optical fiber, the second direction opposite the first direction;
receiving, at the optical power meter, the reflected light pulse at a second time after the first time;
determining, by circuitry associated with the optical power meter, a time delay between the first time and the second time; and
measuring, by the circuitry, a length of the optical fiber based on the time delay.

2. The method of claim 1, wherein the first light pulse is a rectangular light pulse with a pulse width less than 50 microseconds.

3. The method of claim 1, wherein the method further comprises:
coupling a first end of the optical fiber to the optical power meter; and
coupling a second end of the optical fiber to a second light source,
wherein the FBG is disposed between the second end of the optical fiber and the second light source.

4. The method of claim 3, wherein the method further comprises measuring a one-directional optical power loss by:
transmitting, from the second light source, a test light through the optical fiber in the second direction;
receiving, at the optical power meter, the test light; and
measuring, by the optical power meter, an optical power loss of the optical fiber based on a power of the received test light.

5. The method of claim 4, wherein the method further comprises measuring a bidirectional optical power loss by:
receiving, at a power meter of the second light source, at least a portion of a test light emitted from the first light source; and
measuring, by the power meter of the second light source, the optical power loss of the optical fiber based on a power of the received test light.

6. The method of claim 4, wherein the method further comprises measuring a bidirectional optical power loss by:
receiving, at a power meter of the second light source, a CW test light transmitted from the first light source; and
measuring, by the power meter of the second light source, the optical power loss of the optical fiber based on the received CW test light.

7. The method of claim 3, wherein coupling the second end of the optical fiber to the light source comprises:
coupling the optical fiber directly to the second light source;
coupling the optical fiber to a socket-plug-type connector and coupling the socket-plug-type connector to the second light source; or
coupling the optical fiber to a cable-type connector and coupling the cable-type connector to the second light source.

8. The method of claim 1, wherein measuring the length of the optical fiber based on the time delay comprises multiplying the time delay by a speed of light as measured in a fiber and dividing a resultant by a divisor, the divisor calculated as two minus a total length of a test cord.

9. The method of claim 1, wherein the optical fiber is an MPO cable, and wherein the method further comprises successively switching an optical switch between different optical fibers of the MPO cable and measuring the length of the optical fibers based on the time delays.

10. The method of claim 1, wherein the first light pulse is emitted onto the optical fiber at a first end of the optical fiber, and wherein the FBG is disposed at a second end of the optical fiber.

11. An optical fiber loss and length test system comprising:
a first test equipment comprising a first power meter and a first light source optically branched to a first port;
a second test equipment comprising a second light source coupled to a second port; and
circuitry in communication with the first test equipment, the circuitry comprising a processor and a memory storing instructions that, when executed by the processor, cause:
the first light source to generate a first light pulse transmitted to a first end of an optical fiber through the first port at a first time;
the first light pulse to reflect off an FBG disposed at a second end of the optical fiber;
the first power meter to receive a reflected first light pulse at a second time; and
the circuitry to determine a length of the optical fiber based on a time delay between the first and second times.

12. The optical fiber loss and length test system of claim 11, wherein the second light source is configured to generate a CW test light, the CW light received at the first power meter, wherein the circuitry is configured to determine optical power loss of the optical fiber based on a power of the received CW light.

13. The optical fiber loss and length test system of claim 11, wherein the second test equipment further comprises a second power meter, wherein the second power meter is configured to receive at least a portion of a CW test light generated by the first light source, and wherein circuitry in communication with the second test equipment is configured to determine optical power loss of the optical fiber based on a power of the received CW test light.

14. The optical fiber loss and length test system of claim 11, wherein the FBG is disposed external to the optical fiber, and wherein the FBG is disposed at the second equipment, in a socket-plug-type connector, or in a cable-type connector.

15. The optical fiber loss and length test system of claim 14, wherein the socket-plug-type connector or cable-type connector are disposed between the second end of the optical fiber and the second equipment.

16. The optical fiber loss and length test system of claim 11, wherein the first light pulse is a rectangular light pulse with a pulse width less than 50 microseconds.

17. The optical fiber loss and length test system of claim 11, wherein the FBG is configured to reflect a λ₁ wavelength, wherein the first light pulse has a λ₂ wavelength, and wherein λ₂ is approximately equal to λ₁.

18. The optical fiber loss and length test system of claim 11, wherein the second test equipment is free of detection and timer circuitry.

19. The optical fiber loss and length test system of claim 11, wherein the second test equipment further comprises a power meter, and wherein the optical fiber loss and length test system is configured for bidirectional optical loss measurements.

20. The optical fiber loss and length test system of claim 11, wherein the circuitry determines the length of the optical fiber by dividing the time delay by two.
